(19) United States
(12) Patent Application Publication
(10) Pub. No.: US 2020/0089177 A1
(43) Pub. Date: Mar. 19, 2020

(54) DETERMINATION OF USER RESPONSE TO DRIVING EXPERIENCE SIMULATION

(71) Applicant: Pony.ai, Inc., Fremont, CA (US)

(72) Inventors: Chao Tao, Bloomington, IN (US); Xiang Yu, Santa Clara, CA (US); Tiancheng Lou, Milpitas, CA (US); Jun Peng, Fremont, CA (US); Yubo Zhang, Los Gatos, CA (US); Sinan Xiao, Mountain View, CA (US)

(21) Appl. No.: 16/130,918

(22) Filed: Sep. 13, 2018

(51) Int. Cl. G05B 17/02; G01M 17/06; G06F 3/01; A47C 7/62

(52) U.S. Cl. CPC G05B 17/02; G01M 17/06; A47C 7/62; G06F 3/011; G06F 3/016; G06F 3/017

(57) ABSTRACT

Systems, methods, and non-transitory computer readable media may be configured to determine user response to simulation of driving experience. Simulation information may be obtained. The simulation information may define a simulation of driving experience. A simulation of driving experience may include a visual portion, an audio portion, and a motion portion. The visual portion of the simulation may be outputted via a display. The audio portion of the simulation may be outputted via a speaker. The motion portion of the simulation may be outputted via a vibration motor configured to vibrate a seat and motion of the seat along one or more of six-degrees of freedom. A user's response to the simulation of driving experience may be determined via a set of sensors.

### FIELD OF THE INVENTION

This disclosure relates to approaches for determining user response to simulation of driving experience.

### BACKGROUND

Person(s) riding inside a vehicle, such as an autonomous vehicle, may experience forces based on motion of the vehicle. Navigation of the vehicle that creates unpleasant driving experience for person(s) inside the vehicle, such as motion sickness, nausea, or dizziness, is not desirable. However, physically testing different navigations of the vehicle on the road to determine which navigations create unpleasant driving experience for person(s) inside the vehicle may be impractical and costly.

### SUMMARY

Various embodiments of the present disclosure may include systems, methods, and non-transitory computer readable media configured to determine user response to simulation of driving experience. A seat may have six-degrees of freedom. A display may be configured to output images. A speaker may be configured to output sounds. A vibration motor may be configured to vibrate the seat. A set of sensors may be configured to measure a user's response to a simulation of driving experience. Simulation information may be obtained. The simulation information may define a simulation of driving experience. A simulation of driving experience may include a visual portion, an audio portion, and a motion portion. The visual portion of the simulation may be outputted via the display. The audio portion of the simulation may be outputted via the speaker. The motion portion of the simulation may be outputted via the vibration motor and motion of the seat along one or more of the six-degrees of freedom. The user's response to the simulation of driving experience may be determined via the set of sensors.

In some embodiments, the six-degrees of freedom may include three rotational degrees of freedom and three translational degrees of freedom. The six-degrees of freedom may be provided by a hexapod supporting the seat.

In some embodiments, the set of sensors may include an image sensor, a smart seat sensor, and/or a user-activated switch. The image sensor may be configured to capture one or more images of the user during the simulation of driving experience. The smart seat sensor may include a tactile-sensitive surface material. The smart seat sensor may be configured to detect the user's interaction with the tactile-sensitive surface material during the simulation of driving experience. The user-activated switch may be configured to receive the user's input during the simulation of driving experience.

In some embodiments, the simulation of driving experience may include a series of driving maneuver segments. Determining the user's response to the simulation of driving experience may include determining the user's response to individual driving maneuver segments. Determining the user's response to the simulation of driving experience may include determining the user's response to multiples of the driving maneuver segments in sequence.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example environment for determining user response to simulation of driving experience, in accordance with various embodiments.

FIG. 2 illustrates an example environment for determining user response to simulation of driving experience, in accordance with various embodiments.

FIG. 3 illustrates example segments of a simulation of driving experience.

FIG. 4 illustrates a flowchart of an example method, in accordance with various embodiments.

FIG. 5 illustrates a block diagram of an example computer system in which any of the embodiments described herein may be implemented.

### DETAILED DESCRIPTION

In various implementations, a simulation of driving experience may be provided in an environment including a seat, a display, a speaker, a vibration motor, and a set of sensors. A simulation of driving experience may include a visual portion, an audio portion, and a motion portion. A user may be positioned on the seat during the simulation. The seat may have six-degrees of freedom. The six-degrees of freedom may include three rotational degrees of freedom and three translational degrees of freedom. The six-degrees of freedom may be provided by one or more movement mechanisms, such as a hexapod supporting the seat.

The seat may output (e.g., simulate) the motion portion of the simulation via motion along one or more of the six-degrees of freedom. The motion portion of the simulation may be further outputted through use of the vibration motor configured to vibrate the seat, the display, and/or the speaker.

The display may be configured to output images and may output the visual portion of the simulation. For instance, the display may present different images to simulate changes in position of a virtual vehicle during the simulation. The speaker may be configured to output sounds and may output the audio portion of the simulation. For instance, the speaker may playback different sounds to simulate operation of the engine of the virtual vehicle and/or to simulate noises made or encountered by the virtual vehicle during the simulation.

The set of sensors may be configured to measure the user's response to the simulation. The set of sensors may include one or more sensors, such as an image sensor, a smart seat sensor, and/or a user-activated switch. The image sensor may be configured to capture one or more images of the user during the simulation. The smart seat sensor may include a tactile-sensitive surface material. The smart seat sensor may be configured to detect the user's interaction with the tactile-sensitive surface material during the simulation. The user-activated switch may be configured to receive the user's input during the simulation. The user's response to the simulation of driving experience may be determined based on sensor data generated by the set of sensors.

For example, the simulation of driving experience may include a series of driving maneuver segments. The user's response to the simulation of driving experience may be determined by determining the user's response to individual driving maneuver segments. The user's response to the simulation of driving experience may be determined by determining the user's response to multiples of the driving maneuver segments in sequence.

The approaches disclosed herein provides for determination of user response to simulation of driving experience. Rather than physically testing different navigations of the vehicle on the road to determine which navigations create unpleasant driving experience for person(s) inside the vehicle, different navigations of the vehicle are simulated using a seat having six-degrees of freedom, a display, a speaker, a vibration motor, and a set of sensors. The seat, the display, the speaker, and the vibration motor are used to provide different portions of a simulation of driving experience to a user, and the set of sensors are used to observe the user during the simulation. Such simulation of driving experience may be less costly than physically testing different navigations of the vehicle on the road. Such simulation of driving experience may enable testing of variety of navigations, including navigations that may be dangerous on the road or may be impractical to test on the road.

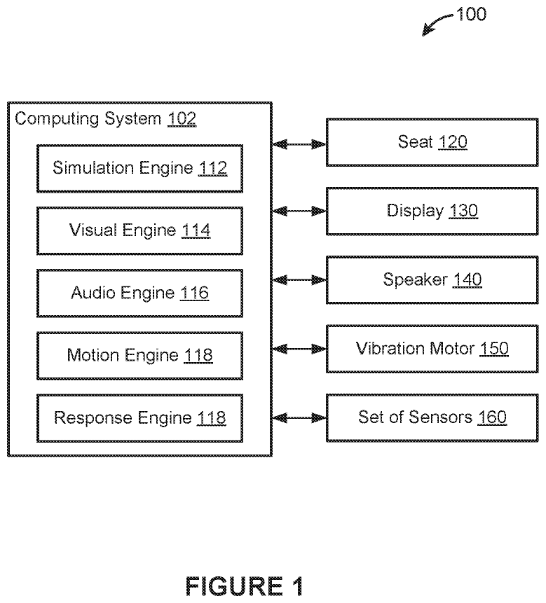

FIG. 1 illustrates an example environment 100 for determining user response to simulation of driving experience, in accordance with various embodiments. The example environment 100 may include a computing system 102, a seat 120, a display 130, a speaker 140, a vibration motor 150, and a set of sensors 160. The computing system 102 may be communicatively, electrically, and/or mechanically coupled to one or more other components of the environment 100. For example, the computing system 102 may be coupled to the display 130, the speaker 140, and the vibration motor 150 to output one or more portions of a simulation of driving experience. The computing system 102 may be coupled to the seat 120 or a device attached to the seat 120 to move the seat along one or more degrees of freedom as part of the simulation. The computing system 102 may be coupled to the set of sensors 160 to receive sensor data from one or more sensors observing a user's response during the simulation. The coupling between the different components within the environment 100 may include direct coupling and/or indirect coupling.

While components 102, 120, 130, 140, 150, 160 of the environment 100 are shown in FIG. 1 as single entities, this is merely for ease of reference and is not meant to be limiting. For example, one or more components/functionalities of the computing system 102 described herein may be implemented, in whole or in part, within a single computing device or within multiple computing devices. The seat 120, the display 130, the speaker 140, the vibration motor 150, and/or the set of sensors 160 may include a single tool/component or multiple tools/components that provide functionalities described herein.

The seat 120 may refer to a thing made or used for sitting on by one or more users. One or more users may be positioned on the seat (e.g., seated, lying down) during a simulation of driving experience. The seat 120 may include a vehicle seat or a portion of a vehicle seat. The seat 120 may be shaped like a vehicle seat. The seat 120 may have six-degrees of freedom. The six-degrees of freedom may include three rotational degrees of freedom and three translational degrees of freedom. That is, the seat 120 may move translationally (e.g., translation in X (forward and backward), Y (left and right), and Z direction (up and down)) and/or may move rotationally (e.g., rotation about X (roll), Y (pitch), and Z axis (yaw)). The seat 120 may include and/or be attached to one or more mechanisms that provide movement along one or more degrees of freedom. For example, the degrees of freedom of the seat 120 may be provided by a hexapod supporting the seat 120. The hexapod may be part of the seat 120 or may be separate from the seat 120. For instance, the hexapod may be integrated into the seat 120 or may be part of a separate device (e.g., platform) that carries the seat 120. As another example, the degrees of freedom of the seat 120 may be provided by one or more of motors, actuators, cables, rods, legs, jacks, and/or other movement mechanisms.

Motion of the seat 120 along one or more of the degrees of freedom may be used to create, for user(s) positioned on the seat 120, the feeling of being in a real motion environment. The motion (translation motion and/or rotational motion) of the seat 120 may be synchronized with one or more of images presented on the display 130, sounds played by the speaker 140, and/or vibration of the seat 120 caused by the vibration motor 150 to create the feeling of movement and/or to enhance the feeling of movement experienced by user(s) positioned on the seat 120.

The display 130 may refer to a tool used to visually present information. The display 130 may present visual information itself (e.g., the display 130 includes a monitor) and/or may present visual information using a projecting surface (e.g., the display 130 includes a projector). The display 130 may refer to a single device (e.g., single monitor) or multiple devices (e.g., multiple monitors) working in coordination to display visual information. The display 130 may be configured to output images. That is, visual information presented (outputted) by the display 130 may include images. Images outputted by the display 130 may simulate scenes that would be seen from a vehicle during a driving experience. For example, the images outputted by the display 130 may include visual representations of objects and/or environment that would be seen by a person inside a vehicle during a driving experience. The images outputted by the display 130 may be pre-recorded (e.g., video frames of a video) and/or dynamically generated during the simulation of driving experience. The images outputted by the display 130 may be synchronized with the motion of the seat 120 to create the feeling of movement and/or to enhance the feeling of movement experienced by user(s) positioned on the seat 120. For example, the images outputted by the display 130 may create the feeling of acceleration or enhance the feeling of acceleration experienced by user(s) positioned on the seat 120 based on changes in the perceived perspective of the environment from the seat (e.g., the display 130 presenting a tilted view of a virtual scenery).

The speaker 140 may refer to a tool used to audibly present information. The speaker 140 may include one or more transducers that convert electrical signals into sound waves. The speaker 140 may refer to a single device (e.g., a single speaker) or multiple devices (e.g., multiple speakers) working in coordination to present audible information. The speaker 140 may be configured to output sounds. That is, audible information presented (outputted) by the speaker 140 may include sounds. Sounds outputted by the speaker 140 may simulate sounds that would be heard from/within a vehicle during a driving experience. For example, the sounds outputted by the speaker 140 may include sounds that would be caused by the vehicle during the driving experience, sounds that would be caused by objects and/or environment around the vehicle during the driving experience, and/or sounds that would be caused by maneuvering of the vehicle during the driving experience. The sounds outputted by the speaker 140 may be pre-generated or pre-recorded (e.g., sound clips stored in electronic storage) and/or dynamically generated during the simulation of driving experience (e.g., procedural audio). The sounds outputted by the speaker 140 may be synchronized with the motion of the seat 120 to create the feeling of movement and/or to enhance the feeling of movement experienced by user(s) positioned on the seat 120. For example, the sounds outputted by the speaker 140 may create the feeling of acceleration or enhance the feeling of acceleration experienced by user(s) positioned on the seat 120 based on changes in frequency and/or amplitude of virtual engine sounds outputted by the speaker 140.

The vibration motor 150 refer to a tool used to generate vibrations. The vibration motor 150 may include one or more motors and/or actuators that are used to generate vibrations. The vibration motor 150 may be configured to vibrate the seat 120. Vibrations generated (outputted) by the vibration motor 150 may simulate vibrations that would be felt from/within a vehicle during a driving experience. For example, the vibrations outputted by the vibration motor 150 may include vibrations that would be caused by the engine or other components of the vehicle during the driving experience, vibrations that would be caused by objects and/or environment around the vehicle during the driving experience (e.g., vibrations caused by wheels of the vehicle rotating on top of a road surface), and/or vibrations that would be caused by maneuvering of the vehicle during the driving experience. The vibrations outputted by the vibration motor 150 may be pre-generated or pre-recorded (e.g., preset vibrations) and/or dynamically generated during the simulation of driving experience (e.g., vibrations generated based on simulation conditions). The vibrations outputted by the vibration motor 150 may be synchronized with the motion of the seat 120 to create the feeling of movement and/or to enhance the feeling of movement experienced by user(s) positioned on the seat 120. For example, the vibrations outputted by the vibration 140 may create the feeling of acceleration or enhance the feeling of acceleration experienced by user(s) positioned on the seat 120 based on changes in frequency and/or amplitude of the vibrations of a virtual vehicle outputted by the vibration motor 140.

The set of sensors 160 include one or more sensors. A sensor may refer to a device that measures (e.g., ascertain, detect, estimate) one or more physical properties. A sensor may record, indicate, and/or otherwise respond to the measured physical propert(ies). For example, the set of sensors 160 may include one or more of an image sensor, a smart seat sensor, a user-activated switch, and/or other sensors. The set of sensors 160 may be configured to measure one or more users' responses to a simulation of driving experience. A user's response to a simulation of a driving experience may refer to how the user reacts to the simulation of driving experience. A user's response to a simulation of a driving experience may indicate whether the user finds the navigation of vehicle (maneuvering of vehicle) simulated by the simulation pleasant or unpleasant.

An image sensor include a sensor that detects and/or conveys information that constitutes an image. The image sensor may be configured to capture one or more images of the user(s) during the simulation of driving experience. The image(s) of the user(s) may depict how the user(s) responded during the simulation of driving experience. The image sensor may be positioned to capture image(s) that include the entire body of the user(s) and/or one or more portions of the user(s) (e.g., capture image(s) including facial expressions of the user(s), capture image(s) showing body positions, postures, and/or motions of the user(s)).

A smart seat sensor may include a sensor that measures a user's interaction with the seat 120. For instance, the smart seat sensor may include one or more tactile-sensitive surface materials, and the smart seat sensor may be configured to detect the user's interaction with the tactile-sensitive surface material during the simulation of driving experience. A tactile-sensitive surface material may include fabric with electrical properties (e.g., resistive properties, conductive properties) woven therein. The tactile-sensitive surface material may disposed on one or more surfaces of the seat 120.

A user-activated switch may include a sensor that detects a user's interaction with a switch. A switch may refer to a device that may be operated by a user into one or more states. The user-activated switch may be configured to receive input from the user(s) during the simulation of driving experience. For example, a user-activated switch may include one or more buttons, switches, dials, and/or other components that may be actuated (e.g., pulled, pushed, flipped, turned, rotated) by a user to provide feedback on the user's experience with the simulation of driving experience. For instance, the user may engage one or more buttons of the user-activated switch to indicate whether a portion of the simulation is pleasant or unpleasant, and/or indicate the level of pleasantness/unpleasantness of the portion of the simulation.

The computing system 102 may include one or more processors and memory. The processor(s) may be configured to perform various operations by interpreting machine-readable instructions stored in the memory. The environment 100 may also include one or more datastores that are accessible to the computing system 102 (e.g., stored in the memory of the computing system 102, coupled to the computing system, accessible via one or more network(s)). In some embodiments, the datastore(s) may include various databases, application functionalities, application/data packages, and/or other data that are available for download, installation, and/or execution. The computing system 102 may include a simulation engine 112, a visual engine 114, an audio engine 116, a motion engine 118, a response engine 120, and/or other engines.

In various embodiments, the simulation engine 112 may be configured to obtain simulation information. Obtaining simulation information may include accessing, acquiring, analyzing, determining, examining, generating, identifying, loading, locating, opening, receiving, retrieving, reviewing, storing, and/or otherwise obtaining the simulation information. Simulation information may be obtained from one or more storage locations. A storage location may refer to electronic storage located within the computing system 102 (e.g., integral and/or removable memory of the computing system 102), electronic storage coupled to the computing system 102, and/or electronic storage located remotely from the computing system 102 (e.g., electronic storage accessible to the computing system 102 through a network). Simulation information may be stored within a single file or across multiple files.

Simulation information may define a simulation of driving experience. A simulation of driving experience may refer to an imitation of driving experience or artificial driving experience. A simulation of driving experience may include a computer model of driving experience. A driving experience modeled by the simulation of driving experience may include real driving experience, such as driving experience that reflects driving of a vehicle that has happened, or virtual driving experience, such as driving experience that reflects driving of a vehicle that has not happened but has been virtually created.

A simulation of real driving experience may be determined and/or generated based on observations of real driving experience. For example, a simulation of real driving experience may be determined and/or generated based on views seen, sounds heard, and/or motion felt during real driving experience. A simulation of real driving experience may include views seen, sounds heard, and/or motion felt during real driving experience. A simulation of real driving experience may enable multiple people to experience an actual driving experience through simulation rather than repeating the real driving experience.

Limiting simulation of driving experience to simulation of real driving experience may not allow for or making it default for users to experience certain types of driving experience. For example, a simulation of driving experience determined and/or generated based on observation of real driving experience may not include rare and/or dangerous driving maneuvers. Limiting simulation of driving experience to simulation of real driving experience may be costly and impractical. For example, performing and recording different driving maneuvers to determine and/or generate varieties of simulations of driving experience may be costly and time consuming.

Using simulations of virtual driving experience may allow users to experience a variety of driving experience without having to observe the different driving experience. For example, a simulation of virtual driving experience may include one or more rare and/or dangerous driving maneuvers of a vehicle. As another example, a simulation of virtual driving experience may include a combination of driving maneuvers that may not have been observed as combined within the simulation.

A simulation of virtual driving experience may be determined and/or generated based on one or more computer models of a vehicle. For example, a simulation of virtual driving experience may be created to include a number of simulated driving maneuvers. A simulation of virtual driving experience may be determined and/or generated based one or more observed driving experience. For example, one or more observed driving experience and/or one or more portions of observed driving experience may be modified for inclusion in a simulation of virtual driving experience. As another example, a portion of an observed driving experience may be combined with a portion of another observed driving experience for inclusion in a simulation of virtual driving experience. As yet another example, a simulation of virtual driving experience may be determined and/or generated based one or more computer models of a vehicle and one or more observed driving experience. For example, an observed driving experience may include a maneuver performed by a vehicle. The sensor data (e.g., image data, audio data, motion data) collected from the observing driving experience may be modified using the computer model(s) to determine and/or generate a simulation of virtual driving experience that includes a modified maneuver performed by the vehicle, a maneuver performed by a different vehicle, and/or a modified maneuver performed by a different vehicle. That is, the observed driving experience may be used as a base model from which a simulation of virtual driving experience is created.

Driving experience may include one or more things or events that may be perceived by a person inside a vehicle during movement of a vehicle. A simulation of driving experience may include one or more portions corresponding to the perceivable things or events. The perceivable things or events of the simulation of driving experience may be include within one or more of a visual portion, an audio portion, and/or a motion portion of the simulation of driving experience. A visual portion may include one or more visual aspects of the simulation. That is, a visual portion of the simulation may include the portion of the simulation that may be visually perceived by a person. The visual portion of the simulation may include images and/or rules defining which images are to be outputted (presented) on the display 130 during the simulation. For example, the visual portion of the simulation may include images to be presented on the display 130 and/or a computer model that generates images to be presented on the display 130 during the simulation. The images may include representations of scenes that would be seen from/within a vehicle during a driving experience simulated by the simulation of driving experience. For example, the images may include representations of objects and/or environment that would be seen by a person inside a vehicle during a driving experience simulated by the simulation of driving experience.

An audio portion may include one or more audible aspects of the simulation. That is, an audio portion of the simulation may include the portion of the simulation that may be audibly perceived by a person. The audio portion of the simulation may include sounds and/or rules defining which sounds are to be outputted (played) through the speaker 140 during the simulation. For example, the audio portion of the simulation may include sounds to be played on the speaker 140 and/or a computer model that generates sounds to be played on the speaker 140 during the simulation. The sounds played on the speaker 140 may include sounds that would be caused by a vehicle, sounds that would be caused by objects and/or environment around the vehicle, and/or sounds that would be caused by maneuvering of the vehicle during a driving experience simulated by the simulation of driving experience.

The motion portion may include one or more motion aspects of the simulation. That is, a motion portion of the simulation may include the portion of the simulation that may be felt by a person. The motion portion of the simulation may include motion (e.g., translational motion, rotational motion, vibration) and/or rules defining which motion are to be outputted (simulated) through the motion of the seat 120 and/or through the vibration motor 150. The motion generated by motion of the seat 120 along one or more degrees of freedom and/or the vibration of the seat 120 may simulate the motion that would be felt by a person in a vehicle during a driving experience simulated by the simulation of driving experience

A simulation of a driving experience may include a series of driving maneuver segments. That is, a simulation of a driving experience may be divided into different parts, with individual parts including one or more corresponding driving maneuvers. A driving maneuver may refer to a movement or a series of movement of a vehicle. For example, a simulation of a driving experience may include different driving maneuvers arranged in a sequence. Such a simulation of driving experience may enable the computing system 102 to determine user response to individual driving maneuvers and/or to determine user response to a combination of driving maneuvers (e.g., determine user response to multiple driving maneuvers that occur in a sequence).

In various embodiments, the visual engine 114 may be configured to output a visual portion of a simulation of driving experience. The visual portion of the simulation may be outputted via the display 130. That is, one or more visual aspects of the simulation may be presented on the display 130. The visual engine 114 may output images included and/or defined by the simulation on the display 130. For example, the visual engine 114 may output different images via the display 130 to simulate changes in position of a virtual vehicle during the simulation. The images outputted by the visual engine 114 may include representations of scenes that would be seen from/within a vehicle during a driving experience simulated by the simulation of driving experience. For example, the images outputted by the visual engine 114 may include representations of objects and/or environment that would be seen by a person inside a vehicle during a driving experience simulated by the simulation of driving experience.

In various embodiments, the audio engine 116 may be configured to output an audio portion of a simulation of driving experience. The audio portion of the simulation may be outputted via the speaker 140. That is, one or more sounds of the simulation may be played through the speaker 140. The audio engine 116 may output sounds included and/or defined by the simulation through the speaker 140. For example, the audio engine 116 may output different sounds to simulate operation of the engine of a virtual vehicle and/or simulate noises made or encountered by the virtual vehicle during the simulation. The sounds outputted by the audio engine 116 may include sounds that would be caused by a vehicle, sounds that would be caused by objects and/or environment around the vehicle, and/or sounds that would be caused by maneuvering of the vehicle during a driving experience simulated by the simulation of driving experience.

In various embodiments, the motion engine 118 may be configured to output a motion portion of a simulation of driving experience. The motion portion of the simulation may be outputted via the vibration motor 150 and/or motion of the seat 120 along one or more degrees of freedom (e.g., one or more of six-degrees of freedom). That is, one or more motion of the simulation may be simulated through vibration generated using the vibration motor 150 and/or motion of the seat 120. The motion engine 118 may output motions included and/or defined by the simulation through the vibration motor 150 and/or the motion of the seat 120. For example, the motion engine 118 may output motions to simulate the motion that would be felt by a person in a vehicle during a driving experience simulated by the simulation of driving experience. The motion portion of the simulation may be further outputted through the use of the display 130 and/or the speaker 140. For example, the vibration and/or the motion of the seat 120 outputted by the motion engine 118 may by synchronized with images presented on the display 130 and/or the sounds played by the speaker 140 to create the feeling of movement and/or to enhance the feeling of movement experienced by user(s) positioned on the seat 120. For instance, the seat 120 may be rotated backwards and the image(s) presented on the display 130 may be rotated to give the user(s) a feeling of force on their back(s) that may be perceived as forward acceleration. The motion engine 118 may utilize one or more washout filters (e.g., classical washout filters including linear low-pass filter (to simulate sustaining accelerations) and high-pass filters (to simulate transient translational and rotational accelerations), adaptive washout filters (including a self-turning mechanism), optimal washout filters (to take into account models for vestibular system)) to suppress low-frequency signals while returning the seat 120 back to a neutral position at accelerations below the threshold of human perception. Such positioning of the seat 120 may enable provision of realistic cues for human perception while respecting limitations of the movement of the seat 120.

In various embodiments, the response engine 120 may be configured to determine one or more user responses to a simulation of driving experience. The user's response to the simulation of driving experience may be determined by the response engine 120 via the set of sensors 160. Determining a user's response via the set of sensors 160 may include determining the user's response to the simulation of driving experience based on sensor data generated by the set of sensors 160. The sensor data generated by the set of sensors 160 may indicate one or more users' responses to the simulation of driving experience. A user response determined by the response engine 120 may include categorization and/or scoring of user responses. For example, the response engine 120 may categorize user responses measured by the set of sensors 160 as suggesting or indicating that the simulation of driving experience (or a portion of the simulation) is pleasant or unpleasant to a user. As another example, response engine 120 may score user responses measured by the set of sensors 160 within a range, with different portions of the range corresponding to the user feeling comfortable during the simulation, the user feeling different levels of comfort, the user feeling uncomfortable, the user feeling different levels of discomfort, and/or other user reaction to the simulation.

For example, based on the set of sensors 160 including an image sensor, the response engine 120 may determine a user response based on one or more images captured by the image sensor during the simulation of driving experience. For instance, image(s) captured by the image sensor may depict how the user responded during the simulation of driving experience, such as how the user's body was positioned and/or the emotion/expression of the user's face. The response engine 120 may categorize the user response captured within the image(s) and/or provide a score (e.g., pleasantness/unpleasantness score) for the simulation based on the user response captured within the image(s).

As another example, based on the set of sensors 160 including a smart seat sensor, the response engine 120 may determine a user response based on one or more user interactions with the tactile-sensitive surface material(s) of the seat 120 during the simulation of driving experience. For example, user interactions with the tactile-sensitive surface material(s) of the seat 120 may indicate different positioning of user body during the simulation of driving experience, such as whether the user was still or shuffling their body during the simulation. The response engine 120 may categorize the user response indicated by user interactions with the tactile-sensitive surface material(s) and/or provide a score (e.g., pleasantness/unpleasantness score) for the simulation based on the user interactions with the tactile-sensitive surface material(s).

As yet another example, based on the set of sensors 160 including a user-activated switch, the response engine 120 may determine a user response based on one or more user interactions with the user-activated switch. For example, user interactions with the user-activated switch may provide feedback on the user's experience with the simulation of driving experience (e.g., whether a portion of the simulation is pleasant or unpleasant, and/or indicate the level of pleasantness/unpleasantness of the portion of the simulation). The response engine 120 may categorize the user response indicated by user interactions with the user-activated switch and/or provide a score (e.g., pleasantness/unpleasantness score) for the simulation based on the user interactions with the user-activated switch.

The response engine 120 may be configured to determine user responses to a simulation of driving experience based on multiple sensors of the set of sensors 160. For example, the response engine 120 may combine and/or integrate sensor data generated by multiple types of sensors and utilize the combined/integrated sensor data to determine user responses. As another example, different sensor data generated by different sensors may be provided as inputs into a machine learning model, which may output the user responses (e.g., categorization and/or scoring of user responses). The sensor data generated by different sensors may be treated equally or differently by the response engine 120. For example, sensor data generated by an image sensor may be weighed the same as sensor data generated by a smart seat sensor in determining user responses. As another example, sensor data generated by a user-activated switch may be weighed more than sensor data generated by a smart seat sensor in determining user responses.

The response engine 120 may be configured to determine user responses to different segments of a simulation of driving experience. For example, a simulation of driving experience may include a series of driving maneuver segments, with the series of driving maneuvers being simulated in a sequence during the simulation. The response engine 120 may determine user responses to individual driving maneuver segments included in the simulation. The response engine 120 may determine user responses to multiples of the maneuver segments in sequence.

For example, a simulation of driving experience may include the following driving maneuvers: slow acceleration, hard braking, left swerve, right swerve, and U-turn. The response engine 120 may determine user responses to the slow acceleration, hard braking, left swerve, right swerve, and U-turn individually. That is, the response engine 120 may categorize and/or score user responses to the slow acceleration maneuver, categorize and/or score user responses to the hard braking maneuver, categorize and/or score user responses to the left swerve maneuver, categorize and/or score user responses to the right swerve maneuver, and/or categorize and/or score user responses to the U-turn maneuver. The response engine 120 may determine user responses to a combination of two or more of the slow acceleration, hard braking, left swerve, right swerve, and U-turn. For instance, the response engine 120 may categorize and/or score user responses to the slow acceleration maneuver followed by the hard braking maneuver, and/or categorize and/or score user responses to the left swerve maneuver, followed by the right swerve maneuver, and followed by the U-turn maneuver. That is, the response engine 120 may categorize and/or score user responses to an accumulation of driving maneuvers. Such determination of user responses may enable the response engine 120 to identify unpleasant driving experience/maneuver that arises not from one/standalone driving experience (e.g., hard braking), but may arise from an accumulation of driving experience (e.g., continuous turns, combination of different driving maneuvers).

The user response(s) to the simulation of driving experience may be used to determine desired or undesired navigation of vehicles. Navigation of a vehicle may refer to planning or directing movement of the vehicle or causing the vehicle to move in a particular way. Navigation of a vehicle may include one or more maneuvering of the vehicle. For example, based on the user responses to a simulation of driving experience indicating that users of the simulation had pleasant experience (or did not have unpleasant experience), vehicle navigation (e.g., individual vehicle maneuvers, combination of vehicle maneuvers) included within the simulation may be provided as an option for navigating vehicles. As another example, based on the user responses to a simulation of driving experience indicating that users of the simulation had unpleasant experience (or did not have pleasant experience), vehicle navigation (e.g., individual vehicle maneuvers, combination of vehicle maneuvers) included within the simulation may be not provided as an option for navigating vehicles or may be ranked lower for selection/provision than other navigation that had higher pleasantness scores or categorization. As yet another example, user responses to simulation of driving experience may be categorized based on one or more commonalities among the users and the navigation of a vehicle may be provided to include maneuvers determined to be pleasant/not unpleasant for specific classes of users. For example, the response engine 120 may separate children's and adults responses to simulation of driving experience, which may enable different navigation of vehicles based on the age of persons riding the vehicles.

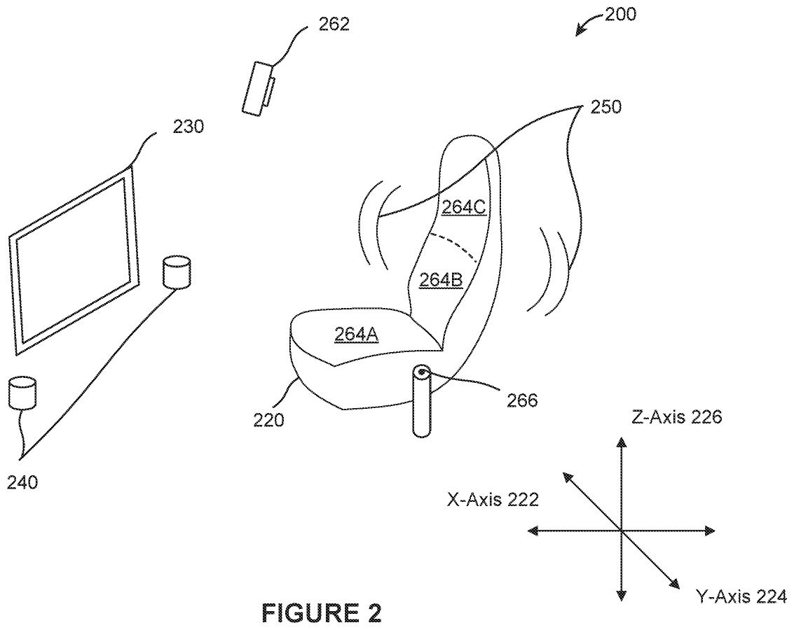

FIG. 2 illustrates an example environment 200 for determining user response to simulation of driving experience, in accordance with various embodiments. The environment 200 may include a seat 220, a display 230, speakers 240, a vibration motor configured to cause vibration 250 of the seat 220, an image capture device 262 (including one or more image sensors), a smart seat sensor including tactile-sensitive surface materials 264A, 264B, 264C, and a user-activated switch 266. The seat 220 may have six-degrees of freedom, including translations and rotations about x-axis 222, y-axis 224, and z-axis 226. A user may be positioned on the seat 220 during a simulation of driving experience. The display 230 may output a visual portion of the simulation. The speakers 240 may output an audio portion of the simulation. A motion portion of the simulation may be outputted via motion of the seat 220 along one or more of the six-degrees of freedom and the vibration 250 of the seat 220. The image capture device 262, the smart seat sensor, and/or the user-activated switch 266 may be used to measure and/or determine user responses to the simulation of driving experience. The simulation and/or one or more portions of the driving experience may be determined to cause pleasant or unpleasant experience for the user positioned on the seat 220. The determination of whether the simulation of the driving experience and/or portion(s) of the simulation of the driving experience cause pleasant/unpleasant experience for the user may be used to determine desired or undesired navigation of vehicles. For example driving experience and/or portion(s) of the driving experience causing unpleasant experience may be tagged so that the same or similar driving experience is not provided to persons in real life.

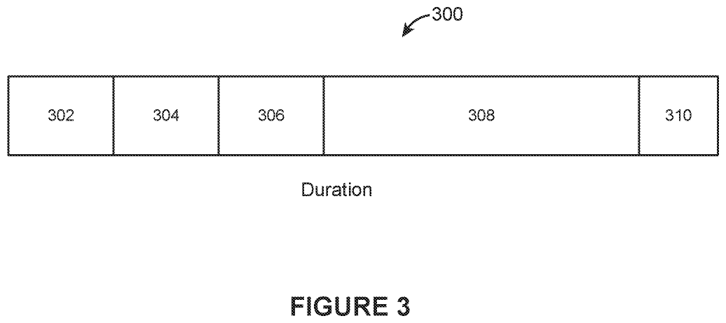

FIG. 3 illustrates example segments of a simulation of driving experience 300. The simulation of driving experience 300 may have a duration. The duration of the simulation may be split into five segments 302, 304, 306, 308, 310. Individual segments 302, 304, 306, 308, 310 may be of same length or different lengths. For example, the segments 302, 304, 306 may be of the same length, the segment 308 may be of longer length than the individual segments 302, 304, 306, and the segment 310 may be of shorter length than the individual segments 302, 304, 306. Individual segments 302, 304, 306, 308, 310 may include one or more driving maneuvers. User response to the simulation of driving experience 300 may be determined based on one or more sensors observing user/user interactions during the simulation of driving experience 300. Determining user responses to the simulation of driving experience 300 may include (1) determining user responses to the entire duration of the simulation of driving experience 300, (2) determining user responses to individual segments 302, 304, 306, 308, 310 of the simulation of driving experience 300, and/or (3) determining user responses to multiples of the segments 302, 304, 306, 308, 310 of the simulation of driving experience 300 in sequence. For example, user responses to the entire simulation (combination of segments 302, 304, 306, 308, 310) may be determined. As another example, user responses to the segment 302 may be determined, user responses to the segment 304 may be determined, user responses to the segment 306 may be determined, user responses to the segment 308 may be determined, and/or user responses to the segment 310 may be determined. As yet another example, user responses to a particular combination of the segments 302, 304, 306, 308, 310 (e.g., combination of the segments 304, 306, 308 in a sequence; combination of the segment 306, followed by a segment of a specified/unspecified segment, followed by the segment 310) may be determined.

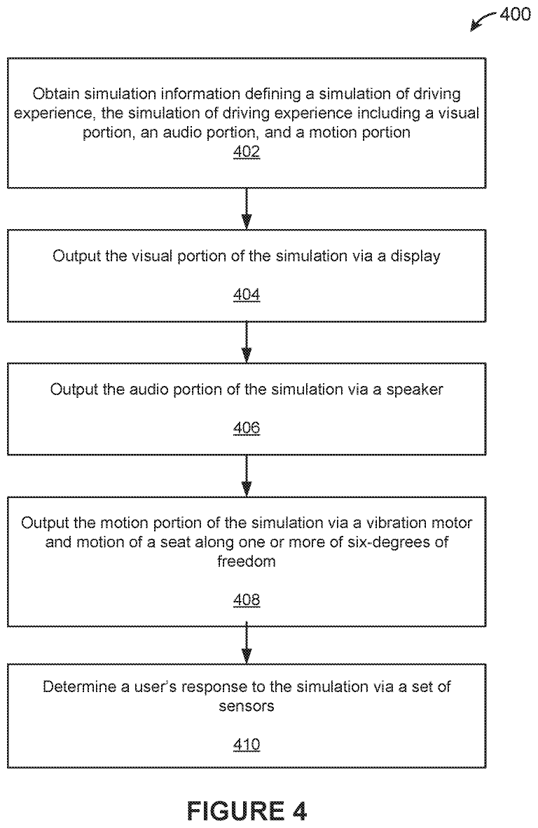

FIG. 4 illustrates a flowchart of an example method 400, according to various embodiments of the present disclosure. The method 400 may be implemented in various environments including, for example, the environment 100 of FIG. 1. The operations of method 400 presented below are intended to be illustrative. Depending on the implementation, the example method 400 may include additional, fewer, or alternative steps performed in various orders or in parallel. The example method 400 may be implemented in various computing systems or devices including one or more processors.

At block 402, simulation information may be obtained. The simulation information may define a simulation of driving experience. The simulation of driving experience may include a visual portion, an audio portion, and a motion portion. At block 404, the visual portion of the simulation may be outputted via a display configured to output images. At block 406, the audio portion of the simulation may be outputted via a speaker configured to output sounds. At block 408, the motion portion of the simulation may be outputted via a vibration motor configured to vibrate a seat and motion of a seat along one or more of six-degrees of freedom. At block 410, a user's response to the simulation of driving experience may be determined via a set of sensors configured to measure the user's response to the simulation of driving experience.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

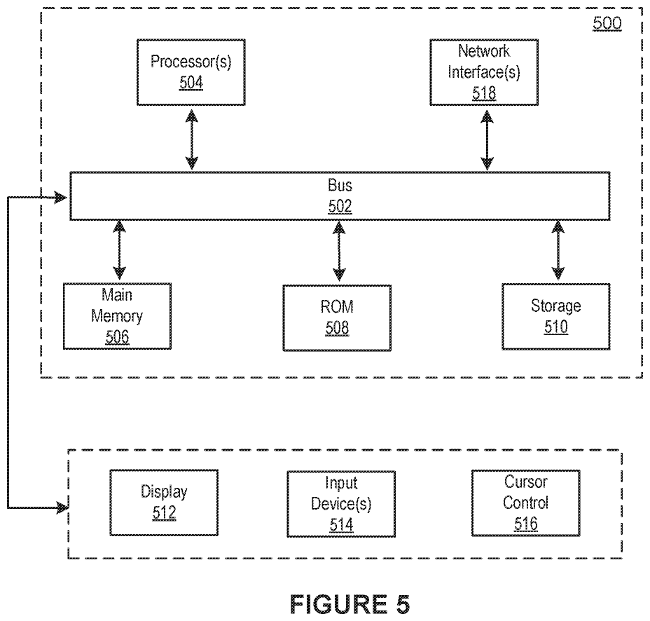

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a cathode ray tube (CRT) or LCD display (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may retrieves and executes the instructions. The instructions received by main memory 506 may optionally be stored on storage device 510 either before or after execution by processor 504.

The computer system 500 also includes a communication interface 518 coupled to bus 502. Communication interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicated with a WAN). Wireless links may also be implemented. In any such implementation, communication interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A system comprising:
a seat having six-degrees of freedom;
a display configured to output images;
a speaker configured to output sounds;
a vibration motor configured to vibrate the seat;
a set of sensors configured to measure a user's response to a simulation of driving experience;
one or more processors; and
a memory storing instructions that, when executed by the one or more processors, cause the system to perform:
obtain simulation information defining the simulation of driving experience, the simulation of driving experience including a visual portion, an audio portion, and a motion portion;
output the visual portion of the simulation via the display;
output the audio portion of the simulation via the speaker;
output the motion portion of the simulation via the vibration motor and motion of the seat along one or more of the six-degrees of freedom; and
determine the user's response to the simulation of driving experience via the set of sensors.

2. The system of claim 1, wherein the six-degrees of freedom includes three rotational degrees of freedom and three translational degrees of freedom.

3. The system of claim 2, wherein the six-degrees of freedom is provided by a hexapod supporting the seat.

4. The system of claim 1, wherein the set of sensors includes an image sensor, the image sensor configured to capture one or more images of the user during the simulation of driving experience.

5. The system of claim 1, wherein the set of sensors includes a smart seat sensor, the smart seat sensor including a tactile-sensitive surface material, the smart seat sensor configured to detect the user's interaction with the tactile-sensitive surface material during the simulation of driving experience.

6. The system of claim 1, wherein the set of sensors includes a user-activated switch, the user-activated switch configured to receive the user's input during the simulation of driving experience.

7. The system of claim 1, wherein the simulation of driving experience includes a series of driving maneuver segments, and determining the user's response to the simulation of driving experience includes determining the user's response to individual driving maneuver segments.

8. The system of claim 1, wherein the simulation of driving experience includes a series of driving maneuver segments, and determining the user's response to the simulation of driving experience includes determining the user's response to multiples of the driving maneuver segments in sequence.

9. A method implemented by a system including one or more processors and storage media storing machine-readable instructions, wherein the method is performed using the one or more processors, the method comprising:
obtaining simulation information defining a simulation of driving experience, the simulation of driving experience including a visual portion, an audio portion, and a motion portion;
outputting the visual portion of the simulation via a display configured to output images;
outputting the audio portion of the simulation via a speaker configured to output sounds;
outputting the motion portion of the simulation via a vibration motor configured to vibrate a seat and motion of the seat along one or more of six-degrees of freedom; and
determining the user's response to the simulation of driving experience via a set of sensors configured to measure the user's response to the simulation of driving experience.

10. The method of claim 9, wherein the six-degrees of freedom includes three rotational degrees of freedom and three translational degrees of freedom.

11. The method of claim 10, wherein the six-degrees of freedom is provided by a hexapod supporting the seat.

12. The method of claim 9, wherein the set of sensors includes an image sensor, the image sensor configured to capture one or more images of the user during the simulation of driving experience.

13. The method of claim 9, wherein the set of sensors includes a smart seat sensor, the smart seat sensor including a tactile-sensitive surface material, the smart seat sensor configured to detect the user's interaction with the tactile-sensitive surface material during the simulation of driving experience.

14. The method of claim 9, wherein the set of sensors includes a user-activated switch, the user-activated switch configured to receive the user's input during the simulation of driving experience.

15. The method of claim 9, wherein the simulation of driving experience includes a series of driving maneuver segments, and determining the user's response to the simulation of driving experience includes determining the user's response to individual driving maneuver segments.

16. The method of claim 9, wherein the simulation of driving experience includes a series of driving maneuver segments, and determining the user's response to the simulation of driving experience includes determining the user's response to multiples of the driving maneuver segments in sequence.

17. A non-transitory computer readable medium comprising instructions that, when executed, cause one or more processors to perform:
obtaining simulation information defining a simulation of driving experience, the simulation of driving experience including a visual portion, an audio portion, and a motion portion;
outputting the visual portion of the simulation via a display configured to output images;
outputting the audio portion of the simulation via a speaker configured to output sounds;
outputting the motion portion of the simulation via a vibration motor configured to vibrate a seat and motion of the seat along one or more of six-degrees of freedom; and
determining the user's response to the simulation of driving experience via a set of sensors configured to measure the user's response to the simulation of driving experience.

18. The non-transitory computer readable medium of claim 17, wherein the set of sensors includes an image sensor configured to capture one or more images of the user during the simulation of driving experience, a smart seat sensor including a tactile-sensitive surface material, the smart seat sensor configured to detect the user's interaction with the tactile-sensitive surface material during the simulation of driving experience, or a user-activated switch configured to receive the user's input during the simulation of driving experience.

19. The non-transitory computer readable medium of claim 17, wherein the simulation of driving experience includes a series of driving maneuver segments, and determining the user's response to the simulation of driving experience includes determining the user's response to individual driving maneuver segments.

20. The non-transitory computer readable medium of claim 17, wherein the simulation of driving experience includes a series of driving maneuver segments, and determining the user's response to the simulation of driving experience includes determining the user's response to multiples of the driving maneuver segments in sequence.
